(19) United States
(12) Patent Application Publication
(10) Pub. No.: US 2003/0223647 A1
(43) Pub. Date: Dec. 4, 2003

(54) Image processing system

(75) Inventors: Ikken So, Ashigarakami-gun (JP); Shinji Shishido, Ashigarakami-gun (JP); Yutaka Koshi, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/378,944

(22) Filed: Mar. 5, 2003

(30) Foreign Application Priority Data
May 31, 2002 (JP) 2002-160350

(51) Int. Cl. G06K 9/36; G06K 9/46

(52) U.S. Cl. 382/248

(57) ABSTRACT

An image processing system that utilizes a CPU is provided. In the image processing system, image data to be processed is separated into plural image data elements, using predetermined requirements. At least one of the image data elements is selected. The selected image data element is subjected to pre-processing including orthogonal transform and quantization to create intermediate data. In order to create compressed data, both the intermediate data and an unselected image data element in the selection are subjected to entropy encoding.

### BACKGROUND OF THE INVENTION

a) Field of the Invention

The present invention relates to an image processing system for compressing image data.

b) Description of Related Arts

Recently, the JPEG2000 standard (Joint Picture Experts Group 2000, hereinafter referred to as “J2K”) has been developed as a standard method of compressing image data of natural images (e.g. photographs). The operation for standardizing the J2K has been being fostered. J2K are commonly offered in the form of programs for execution by general purpose computers. The basic functional blocks, as shown in FIG. 6, include a Wavelet transform unit 1, a quantization unit 2, an entropy encoding unit 3, and a code output unit 4. Operations of these units are summarized below. Detailed description of the operation of each unit is described in detail in various public J2K specifications of the J2K.

The Wavelet transform unit 1 separates image data into plural sets of information concerning spatial frequency spectra. The quantization unit 2 creates and outputs information obtained by quantizing information about each spatial frequency spectrum separated by the Wavelet transform unit 1. The entropy encoding unit 3 performs entropy encoding for each set of quantized information and then outputs the result as a compressed process result.

The entropy encoding unit 3 employs EBCOT (Embedded Block Coding with Optimized Truncation) to divide the quantized information into bit planes and to then further divide each bit plane into sub-bit planes. In division to sub-bit planes, each bit plane is divided into a plane which includes information predicted to be significant for decoding, a plane which includes information predicted not to be significant but to affect reproduction, and a plane which includes information predicted to be neither significant nor of affect. The entry encoding unit 3 performs an algebraic encoding to each bit in a sub-bit plane.

The code output unit 4 creates and outputs a bit stream, as a compressed result, based on information sequentially input in accordance with information about each spatial frequency spectrum. More specifically, the code output unit 4 outputs a data structure in which information regarding compressed results corresponding to information regarding various spectra are arranged in order of increasing spatial frequencies.

However, because the J2K compression method is direction at compression of image data of natural images, the compression efficiency of text images or computer graphic (CG) images, which contain many high-frequency spectra, is relatively low and reproducibility is impaired.

However, because a considerable number of image data is composed of a combination of natural images and text images, there has been a demand to modify the J2K compression method in order to improve the efficiency of compression of text images or CG images, while maintaining or enhancing the efficiency of compression of natural images.

In the so-called MRC (Mixed Raster Context) method, image data is separated into natural image and text or CG image data, the J2K method is applied to the natural image portion, and a compression process other than J2K is applied to the remaining data. This method is now being formulated as J2K part 6. However, because the J2K part 6 method requires that an inherent encoding function be packaged for each subset of image data portion, the program size becomes undesirably large.

### SUMMARY OF THE INVENTION

The present invention was made to overcome the above-mentioned problems, and the present invention advantageously provides an image processing system capable of improving encoding efficiency without increasing program size.

According to an aspect of the present invention, an image processing system comprises a separator for separating image data to be processed into plural image data elements, based on predetermined criteria; a selector for selecting at least one image data element obtained by the separator; means for performing pre-processing, including orthogonal transform and quantization, on the selected image data element and thus creating intermediate data; and means for performing entropy encoding of the intermediate data and to image data element not selected by the selector and thus creating compressed data.

According to another aspect of the present invention, an image processing system comprises a separator for separating image data to be processed into plural image data elements based on predetermined criteria; a selector for selecting at least one image data element obtained by the separator; means for performing pre-processing, including orthogonal transform and quantization, on the selected image data element and thus creating first intermediate data; means for performing a predetermined process, different from the pre-processing, on image data element not selected by the selector and thus creating second intermediate data; and means for performing entropy encoding of the first intermediate data and the second intermediate data and thus creating compressed data.

According to one aspect of the present invention, the image data to be processed contains data for plural pages, and the separator separates the image data into image data elements in page units.

According to another aspect of the present invention, the image data to be processed is described using a predetermined descriptive language. The separator separates the image data into image data elements, in conjunction with interpretation of the descriptive language.

According to another aspect of the present invention, the separator separates a set of pixels contained in the image data to be processed into pixel subsets comprising no pixels common to each other, based on predetermined criteria, and creates the plural image data elements each including the separated pixel subsets, whereby the image data is separated into the plural image data elements.

According to a still further aspect of the present invention, the separator divides the image data to be processed into plural pixel blocks and separates the image data into the image data elements in the pixel block units.

According to another aspect of the present invention, the orthogonal transform is a discrete Wavelet transform.

According to a further aspect of the present invention, the entropy encoding includes a bit plane dividing process, an algebraic encoding process, and a bit truncating process.

According to another aspect of the present invention, a compressed data producing method comprises the steps of separating image data to be processed into plural image data elements based on predetermined criteria; selecting at least one image data element obtained by the separating step; performing pre-processing, including orthogonal transform and quantization, on the selected image data element and thus creating intermediate data; and performing entropy encoding to the intermediate data and to image data element not selected by the selecting step and thus creating compressed data.

According to another aspect of the present invention, an image processing program executed by a computer, caused the computer to execute processes for separating image data to be processed into plural image data elements, using predetermined criteria; selecting at least one image data element obtained by the separating process; performing pre-processing, including orthogonal transform and quantization, on the selected image data elements and thus creating intermediate data; and performing entropy encoding to the intermediate data and to image data element not selected by the selecting process and thus creating compressed data.

According to still another aspect of the present invention, a compressed data structure comprises a first data element which can create a first image data element through a process including an entropy decoding process, an inverse quantization process, an orthogonal transform process; and a second data element which can create a second image data element through a process including an entropy decoding process and not including at least one of an inverse quantization process and an orthogonal transform process.

### BRIEF DESCRIPTION OF THE DRAWINGS

These and other features and advantages of the present invention will become more apparent from the following detailed description taken in conjunction with the attached drawings, in which:

FIG. 1 is a block diagram illustrating the configuration of an example image processing system according to the present invention;

FIG. 2 is a functional block diagram illustrating an image processing program according to a first embodiment of the present invention;

FIG. 3 is an explanatory diagram showing an example of the data structure created by the image processing system according to the present invention;

FIG. 4 is a flowchart showing an example of operation of the data separator;

FIG. 5 is a functional block diagram of an image processing system according to a second embodiment of the present invention; and

FIG. 6 is a functional block diagram illustrating the JPEG 2000 compression process.

### DESCRIPTION OF THE EMBODIMENTS

First Embodiment

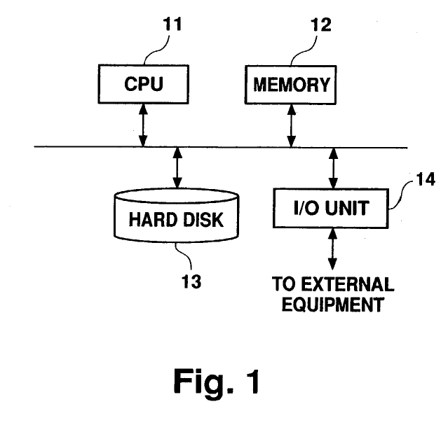

A first embodiment of the present invention will be described below by referring to the attached drawings. In the first embodiment, an image processing system can be generally realized using a computer. Specifically, the image processing system, as shown in FIG. 1, includes a CPU 11, a memory 12, a hard disk 13, and an input/output unit 14.

The CPU 11 operates in accordance with the program stored in the hard disk 13. The CPU 11 stores input image data in the memory 12 as a process object, performs a compression process on the input data, and then stores the results in the memory 12. The compression process result is output via the input/output unit 14. The specific content of the compression process will be described in detail later. The memory 12 is a rewritable memory, which works as a work memory for the CPU 11. The hard disk 13, which is an example of a computer readable recording medium, stores the program executed by the CPU 11. The input/output unit 14, which may be, for example, an USB (Universal Serial Bus) or a network interface, outputs external data to the CPU 11, and outputs data outside in accordance with the instruction input from the CPU 11.

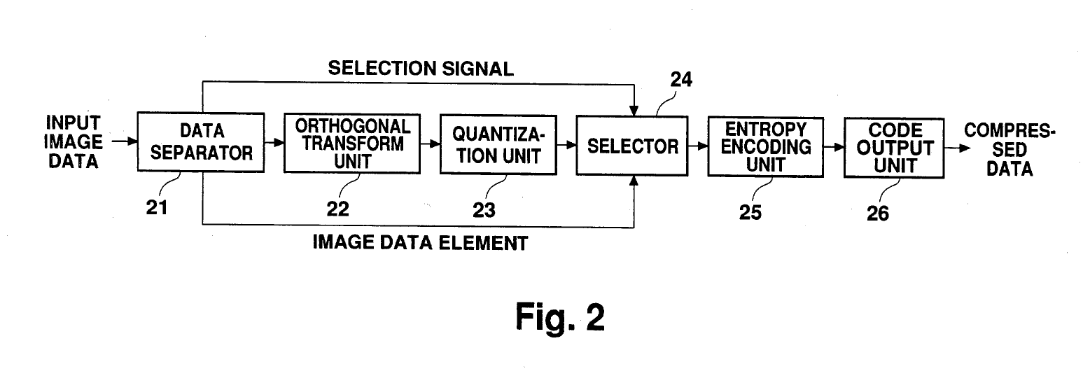

Here, the content of a compression process executed by the CPU 11 will be explained. The image processing program stored in the hard disk 13 includes functions as shown in FIG. 2. That is, the program includes a data separator 21, an orthogonal transform unit 22, a quantization unit 23, a selector 24, an entropy encoding unit 25, and a code output unit 26. The data separator 21 reads image data to be processed, separates the image data into image data elements in predetermined units in accordance with predetermined requirements, creates a selection signal representing whether or not an orthogonal transform process is to be applied, and then outputs the selection signal to the selector 24. The data separator 21 outputs, without any modification, each image data element to the orthogonal transform unit 22 and the selector 24. Next, a specific example of the image data element output by the data separator 21 will be described in detail.

The orthogonal transform unit 22 performs orthogonal transform processing on the image data element from the data separator 21 and then outputs the result. Specifically, the orthogonal transform unit 22 extracts respective pixel values contained in the image data element in a predetermined order, creates a vector value formed of pixel values, performs an orthogonal transform of the vector value, using, e.g. the DWT (Discrete Wavelet Transform), and then outputs the result. The quantization unit 23 quantizes the orthogonal transform result output from the orthogonal transform unit 22 and then outputs the quantized result as intermediate data. As the operation of the orthogonal transform unit 22 and the quantization unit 23 is well known from the JPEG or J2K specifications, a detailed explanation will be omitted here.

The selector 24 selectively outputs either the image data element itself from the data separator 21 or intermediate data from the quantization unit 23, based on the selection signal from the quantization unit 23. Specifically, when the selection signal is subjected to the orthogonal transform, the selector 24 selects intermediate data from the quantization unit 23 and then outputs the selected data to the entropy encoding unit 25. When the selection signal is not subjected to the orthogonal transform, the selector 24 selects the image data element itself from the data separator 21 and then outputs it to the entropy encoding unit 25.

In other words, the combination of the data separator 21 and the selector 24 separates the image data to be processed into units of predetermined image data elements and decides whether or not each image data element is subjected to an orthogonal transform. Moreover, that combination selects executing or bypassing the process, which includes orthogonal transform process and quantization process, to the image data element, in accordance with the decision result.

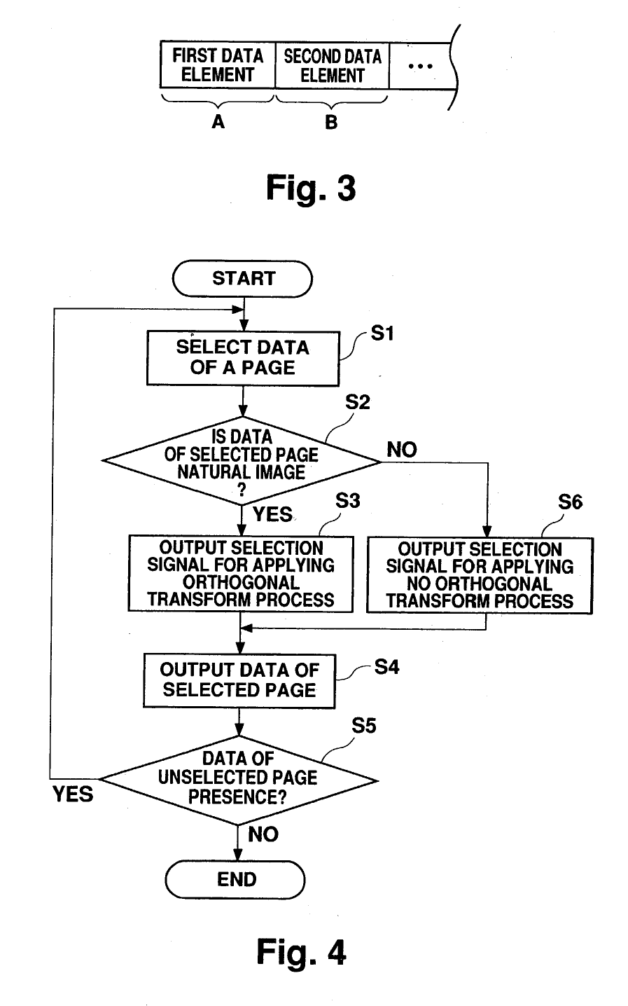

The entropy encoding unit 25 executes at least a bit plane dividing process, an algebraic encoding process, and a bit truncating process on data output from the selector 24, and thus compresses the data. Specifically, EBCOT similar to a conventional element may be used for the entropy encoding unit 25. The code output unit 26 compiles compression process results of respective image data elements into a series of data files and then stores these in the memory 12. The data structure of the data file includes a first data element (A) and a second data element (B), as shown in FIG. 3. The first data element (A) corresponds to the image data element subjected to an orthogonal transform process, to a quantization process, and to an entropy encoding. The second data element (B) corresponds to the image data element subjected only to entropy encoding. The first data element corresponds to the portion wherein the original image data element can be reproduced through the decoding process corresponding to entropy encoding and through the inverse quantization process and through the inverse transform process corresponding to orthogonal transform. The second data element corresponds to the portion wherein the original image data element can be reproduced through the decoding process corresponding to entropy encoding. Thus, the natural image portion is efficiently compressed through the orthogonal transform process and the quantization process and the entropy encoding. As to other portions, the orthogonal transform process and the quantization process are bypassed, and only the entropy encoding is performed. As a result, the other portions are efficiently compressed. In this operation, because the portions other than the natural image are subjected to the J2K entropy encoding process, the program size can be prevented from being increased.

The image data element output from the data separator 21 is, for example, data in page units. Operation of the data separator 21 will be described below using specific example cases. That is, the cases includes a case wherein data is separated in page units, a case wherein data is separated in conjunction with a descriptive language, a case wherein data is separated in pixel unit, and a case wherein data is separated in block unit.

In the case wherein data is separated in page units, the data separator 21 starts the process shown in FIG. 4 in response to input of plural pages of image data. Then, the data separator 21 sequentially selects data of respective pages contained in image data (S1), and then decides whether or not the selected data corresponds to a natural image (e.g. photograph) (S2). When the selected data corresponds to a natural image (Yes), the data separator 21 outputs the selection signal representing application of an orthogonal transform process, to the selector 24 (S3). The data separator 21 then outputs data (image data element) corresponding, to the page to the orthogonal transform unit 22 and to the selector 24 (S4). The data separator 21 decides whether or not data corresponding to an unselected page is present among sets of input image data (S5). When it is determined that data corresponding to an unselected page is present (Yes), the process returns to the step S1 and the process is repeated. If it is determined at step S5 that there is no data corresponding to an unselected page, or when data corresponding to all pages has been processed (No), the process ends. When it is determined at step S2 that selected data does not corresponds to a natural image (No), the selection signal representing that an orthogonal transform process is not to be applied is output to the selector 24 (S6), and the process continues on to step S4.

When it is decided at step S2 that data of a certain page contains a natural image along with other data portions, the selection signal is output based on the previous setting. For example, when data of a selected page contains both a natural image and other portions, outputting of the selection signal not applied to the orthogonal transform process allows the image quality at the reproduction time to be improved, but at the sacrifice of compression efficiency. On the other hand, when the setting is made to output the selection signal for applying the orthogonal transform process, the compression efficiency can be improved, but at the sacrifice of the image quality at the reproduction time. Furthermore, by discriminating the degree that the natural image is contained, when the ratio is larger than the threshold value previously set, the selection signal for applying the orthogonal transform process may be output. If not so, the selection signal not applying the orthogonal transform process may be output.

Moreover, in the step S2 the information representing whether or not data corresponds to a natural image may be previously attached for each page. When this is done, subsequent decisions may be made with reference to the information. Alternately, an existing process such as texture analysis may be used to decide whether or not data corresponds to a natural image.

In a case wherein image data is separated in conjunction with descriptive language, when image data to be processed is described with a descriptive language such as PostScript (registered trademark), the data separator 21 operates as a rasterizer that creates visible image data, based on the descriptive language. In the course of operating as the rasterizer, the data separator 21 separates data into image data elements, in connection with the process of interpreting the descriptive language. For example, the data separator 21 separates bit-map data portion including a natural image and other data portions, such as bit-map data of CG or text data, into respective image data elements. Thus, when the bit map data portion of a natural image is output, the data separator 21 outputs the selection signal applying the orthogonal transform process to the corresponding portion. Moreover, when bit-map data of CG or text data is output, the data separator 21 outputs the selection signal representing that an orthogonal transform process is not applied, to the corresponding portion. That is, image data elements are separated in object units.

In a case wherein data is separated in pixel units, when the image data to be processed is raster image data, the data separator 21 creates a first plane, a second plane, and mask data, according to whether or not each pixel is a pixel forming a natural image, as respective pixels of image data are sequentially selected. The first plane contains bit-map data formed of pixels forming a natural image. The second plane contains bit-map data forming pixels not forming a natural image. The mask data indicate the plane to which respective pixels contained in image data to be processed belong. The data separator 21 outputs the selection signal applying the orthogonal transform process to the selector 24 and outputs the first plane to the orthogonal transform unit 22 and the selector 24. The data separator 21 outputs the selection signal without applying the orthogonal transform process to the selector 24, and outputs the second plane to the orthogonal transform unit 22 and the selector 24.

In this operation, both the orthogonal transform and quantization are performed on the data in the first plane but are bypassed around the second plane and the mask data.

In a case wherein data is separated in block units, such as in a J2K compliant compression method, it may be preferable to determine whether or not the orthogonal transfer process is applied to each pixel block. In such a case, the data separator 21 sequentially selects respective pixel blocks and decides whether or not each selected pixel block forms a pixel block partially forming a natural image. Upon deciding that a selected pixel block is a portion of a natural image, the data separator 21 outputs the selection signal applying the orthogonal transfer process, to the selector 24, and outputs the corresponding pixel block to the orthogonal transform unit 22 and the selector 24. Upon deciding that a selected pixel block is not a portion of a natural image, the data separator 21 outputs the selection signal not applying the orthogonal transform process, to the selector 24, and outputs the corresponding pixel block to the orthogonal transform unit 22 and the selector 24.

Next, operation of the image processing system in the present embodiment will be described. When receiving image data to be processed, the CPU 11 determines, as the process of the data separator 21, whether or not the orthogonal transform process is to be applied to each image data element in a predetermined unit, and then stores the selection signal in the memory 12 in accordance with the results of the determination. The predetermined unit may be, for example, page units, units determined in conjunction with a descriptive language, pixel units, or block units. The CPU 11 stores the corresponding image element in the memory 12 and then begins the process of the orthogonal transform unit 22.

As the process of the orthogonal transform unit 22, the CPU 11 applies an orthogonal transform process to an image data element stored in the memory 12 and stores the results obtained in the memory 12. The CPU 11 then executes the quantizing process of the quantization unit 23 on the results and stores the intermediate data in the memory 12 as the quantization result.

As the process of the selector 24, the CPU 11 refers to the selection signal stored in the memory 12. When the selection signal is the signal indicating application of the orthogonal transform process, the CPU 11 selectively reads intermediate data stored in the memory 12, executes the process of the entropy encoding unit 25, and then stores the result as a compressed data element in the memory 12.

When the selection signal stored in the memory 12 is a signal indicating that the orthogonal transform process is not to be applied, the CPU 11 selectively reads the image data element stored in the memory 12, executes the process of the entropy encoding unit 25, and then stores the results in the memory 12 as a compressed data element.

Furthermore, the CPU 11 determines whether or not unprocessed image data elements are present. When unprocessed image data elements are found, the CPU 11 selects one of the corresponding image data elements and repeats the processing based on the decision as to whether or not the orthogonal transform process is applied. When no unprocessed image data is found, the CPU 11, in the process of the code outputting unit 26, compiles compression process results of respective image data elements in a series of data files, and then stores these data files in the memory 12.

The compression data thus obtained contains a first data component (A) and a second data component (B), as shown in FIG. 3. The first data component (A) corresponds to an image data element subjected to the orthogonal transform process, the quantization process, and entropy encoding. The second data component (B) corresponds to an image data element subjected only to entropy encoding. In decoding, by subjecting the first data element to a decoding process corresponding to entropy encoding and to an inverse quantization process and to an inverse transform process corresponding to orthogonal transform, the original data element is reproduced. By subjecting the second data element to a decoding process corresponding to entropy encoding, the original image data element is reproduced. Thereafter, the original data is reproduced based on each image data element.

Second Embodiment

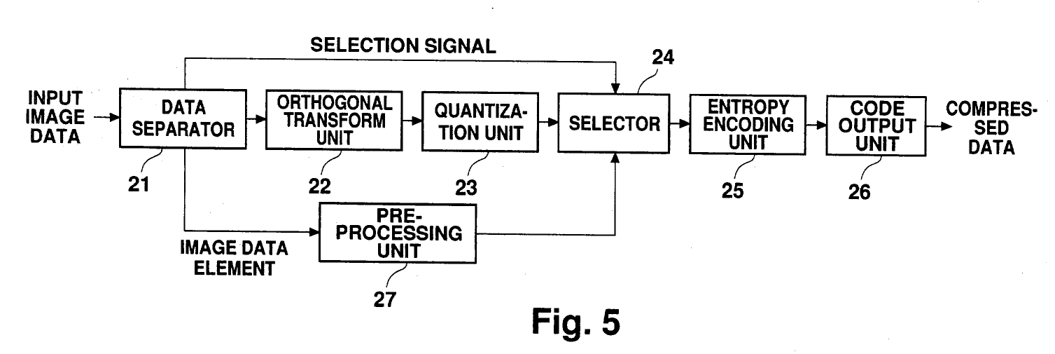

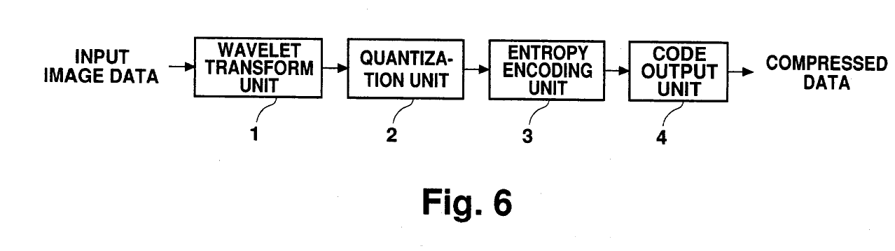

Next, a second embodiment of the present invention will be described. The image processing system in the second embodiment is similar to that in the first embodiment, and differs primarily in that the image data element, not subjected to the orthogonal transform process and the quantization process, undergoes an entropy encoding preprocessing, without being directly subjected to the entropy encoding. That is, the image processing system has a configuration similar to that in the first embodiment shown in FIG. 1. As shown in FIG. 5, the image processing program, executed by the CPU 11, includes a data separator 21, an orthogonal transform unit 22, a quantization unit 23, a selector 24, an entropy encoding unit 25, a code output unit 26, and a pre-processing unit 27.

Those functions corresponding to those in the first embodiment are labeled with the same numerals and their description will not be repeated here. The pre-processing unit 27 receives an image data element from the data separator 21, applies a predetermined process to the data element, and then outputs the results to the selector 24. Specifically, in this example, a predictive encoding process is performed as the predetermined previous process. For example, respective pixels forming an image data element are sequentially selected along a predetermined path. When a selected pixel has the same value as a pixel already selected, the code representing that the already-selected pixel value is attached, without modification, to the subsequent pixel. This improves the efficiency of the entropy encoding process.

In the image processing system of the second embodiment, when receiving image data to be processed, the CPU 11 determines, as the process of the data separator 21, whether or not each image data element is applied to an orthogonal transform process in predetermined unit. The predetermined unit may be, for example, a page unit, a unit determined in conjunction with a descriptive language, a pixel unit, or a block unit. Thus, the CPU 11 stores the selection signal corresponding to the decision result in the memory 12. The CPU 11 also stores the image data element in the memory 12 and then begins the process of the orthogonal transform process 22.

In order to realize the process of the orthogonal transform process unit 22, the CPU 11 applies an orthogonal transform process to the image data element stored in the memory 12, and then stores the resulting data in the memory 12. Next, the CPU 11 executes the quantization process of the quantization unit 23 and then stores the quantized intermediate data in the memory 12.

In order to realize the process of the pre-processing unit 27, the CPU 11 applies preprocessing to the image data element stored in the memory 12, and then stores the resulting data in the memory 12. Next, in order to realize the process of the selector 24, the CPU 11 refers to the selection signal stored in the memory 12. When the selection signal is the signal representing that an orthogonal transform process is applied, the CPU 11 selectively reads the intermediate data stored in the memory 12 and executes the process of the entropy encoding unit 25. Then, the CPU 11 stores the resulting data as a compressed data element in the memory 12.

When the selection signal stored in the memory 12 is a signal indicating that no orthogonal transform process is to be applied, the CPU 11 selectively reads the previously-processed image data element stored in the memory 12 and executes the process of the entropy encoding unit 25. Thus, the CPU 11 outputs the results to the memory 12 as a compressed data element.

The CPU 11 determines whether or not there are unprocessed image data elements. If it is determined that there exist unprocessed image data elements, the CPU 11 selects one of the image data elements. Then, the process is repeated based on the decision as to whether or not an orthogonal transform process is to be applied. If there is no unprocessed image data element, the CPU 11 compiles compression process results for respective image data elements into a series of data files and then stores these in the memory 12.

The compressed data thus obtained has the structure shown in FIG. 3. In the compressed data created by the image processing system of the second embodiment, the second data element (B) corresponds to the image data element subjected to both the previous process and the entropy encoding. Consequently, during decoding, the original data element is reproduced by applying the first data factor to the decoding process corresponding to the entropy encoding and the inverse quantization process and the inverse transform process corresponding to orthogonal transform. Meanwhile, the original data element is reproduced by applying the second data element to the decoding process corresponding to entropy encoding and the decoding process corresponding to the previous process. Thereafter, the original image data is reproduced from respective image data elements.

Although in the above examples the image data elements related to a natural image are subjected to an orthogonal transform process and a quantization process, the present invention is not limited to this configuration. For example, other processes may be performed in addition to the two processes.

What is claimed is:

1. An image processing system, comprising:
a separator for separating image data to be processed into plural image data elements based on predetermined criteria;
a selector for selecting at least one image data element obtained by the separator;
means for performing pre-processing, including orthogonal transform and quantization, on the selected image data element and thus creating intermediate data; and
means for performing entropy encoding of the intermediate data and to image data element not selected by the selector and thus creating compressed data.

2. An image processing system, comprising:
a separator for separating image data to be processed into plural image data elements based on predetermined criteria;
a selector for selecting at least one image data element obtained by the separator;
means for performing pre-processing, including orthogonal transform and quantization, on the selected image data element and thus creating first intermediate data;
means for performing a predetermined process, different from the pre-processing, on image data element not selected by the selector and thus creating second intermediate data; and
means for performing entropy encoding of the first intermediate data and to the second intermediate data and thus creating compressed data.

3. The image processing system according to claim 1, wherein the image data to be processed contains data for plural pages; and wherein the separator separates the image data into image data elements in page units.

4. The image processing system according to claim 1, wherein the image data to be processed is described using a predetermined descriptive language; and wherein the separator separates the image data into the image data elements, in conjunction with interpretation of the descriptive language.

5. The imaging processing system according to claim 1, wherein the separator separates a set of pixels contained in the image data to be processed into pixel subsets comprising no pixels common to each other based n predetermined criteria, and creates the plural image data elements each including the separated pixel subsets, whereby the image data is separated into the plural image data elements.

6. The image processing system according to claim 1, wherein the separator divides the image data to be processed into plural pixel blocks and separates the image data into image data elements in pixel block units.

7. The image processing system according to claim 1, wherein the orthogonal transform is a discrete Wavelet transform.

8. The image processing system according to claim 1, wherein the entropy encoding includes a bit plane dividing process, an algebraic encoding process, and a bit truncating process.

9. A compressed data producing method comprising the steps of:
separating image data to be processed into plural image data elements based on predetermined criteria;
selecting at least one image data element obtained from the separating step;
performing pre-processing, including orthogonal transform and quantization, on the selected image data element and thus creating intermediate data; and
performing entropy encoding of the intermediate data and to image data element not selected by the selecting step and thus creating compressed data.

10. An image processing program which, when executed by a computer, caused the computer to execute processes for:
separating image data to be processed into plural image data elements based on predetermined criteria;
selecting at least one image data element obtained as a result of the separating process;
performing pre-processing, including orthogonal transform and quantization, on the selected image data elements and thus creating intermediate data; and
performing entropy encoding of the intermediate data and to image data element not selected by the selecting process and thus creating compressed data.

11. A compressed data structure, comprising:
a first data element which can create a first image data element through a process including an entropy decoding process, an inverse quantization process, an orthogonal transform process; and
a second data element which can create a second image data element through a process including an entropy decoding process and not including at least one of an inverse quantization process and an orthogonal transform process.
